(19) United States
(12) Patent Application Publication
(10) Pub. No.: US 2009/0139094 A1
(43) Pub. Date: Jun. 4, 2009

(54) Coconut Splitting Device

(76) Inventor: Pierre Beloin, Pincourt (CA)

Correspondence Address: INVENTARIUM, SUITE 1607, 4050, ROSEMONT, MONTREAL, QC, H1X1M4, CA

(21) Appl. No.: 11/950,330

(22) Filed: Dec. 4, 2007

(51) Int. Cl. A23N 5/03

(52) U.S. Cl. 30/120.1

(57) ABSTRACT

A coconut splitting device has a lowering means to lower a coconut onto blades. The blades splitting the coconut. A liquid container to collect liquid from the split coconut.

This application claims priority based on provisional application 60/872,381 filed Dec. 4, 2006

### FIELD OF THE INVENTION

The present invention relates generally to devices used in food preparation and more particularly to an externally powered device to split a coconut open efficiently and collect its water.

### BACKGROUND OF THE INVENTION

The coconut and its multiple uses and properties has been known and utilised for thousands of years. People, especially living in tropical countries and island communities have used and continue to use the coconut in many facets of daily life, in some instances even as currency. The husk of the coconut, or fibre, is used to make coir which in turn has a multitude of applications. The water inside the coconut or tender coconut water as it is better known is a refreshing drink which has many healing properties including being a substitute for blood. The white fleshy interior is tasty and can be eaten as is, grated, chopped, cooked or used to flavor foods. Coconut oil and milk, which have additional applications, can also be extracted from the flesh. The hard shell is fashioned into ladles, cups and other household and decorative objects.

Needless to say the coconut's beneficial uses have been discovered and used for centuries in Asia and other tropical parts of the world. People of these regions have the skills to pick them off the tree, tear the husk off, break the coconut and use its various components with an expertise that has been passed on from one generation to the next. They do so using very basic tools even today.

As the coconut enters today's world, people the world over are becoming aware of its many beneficial health and cooking uses. However it is still a tough nut to crack, no pun intended and many homes as well as restaurants could derive benefits from using fresh coconuts in everyday cooking but for the difficulty or art needed in breaking them open. Industrially there are methods to break large numbers of coconuts open, but no such device which addresses individuals, homes and restaurants.

Current methods and tools used are unsafe, difficult to wield, messy and need skill, thereby deterring a layperson, housewife, chef or restaurant from using fresh coconuts in their cooking more often.

The only prior art that has any semblance of relevance to splitting coconuts would be inventions related to log splitting. The problem is that one cannot simply resize a log splitting machine so that it can sit on a kitchen counter in order to produce a coconut splitting device and as such it requires more than a simple obvious variant in order to produce a suitable coconut splitting device.

The present invention addresses the need for a practical device operable by a layperson to break coconuts open. The invention provides for an efficient, clean, safe and reliable method of splitting coconuts open with an electrically operated device designed for homes and restaurants.

### SUMMARY OF THE INVENTION

In view of the foregoing disadvantages inherent in the known devices now present in the prior art, the present invention, which will be described subsequently in greater detail, is to provide objects and advantages which are:

To provide for a coconut splitting device that meets all the criteria of sanitation so as to be used in commercial kitchens as well as home kitchens.

To provide for a device that is safe to use.

To provide for a device that recuperates the milk contained inside the coconut (no log splitting machine is designed to recoup any form of liquids from logs they split).

To attain these ends, the present invention generally comprises a lowering means to lower a coconut onto blades, the blades splitting the coconut, and a liquid container to collect liquid from the split coconut.

More specifically, the lowering means is in the form of an electrically powered motor with a motor shaft extending therefrom. The motor shaft is itself mechanically attached to a motor pulley. The motor pulley drives a closed belt to which it is mechanically connected. A pair of leadscrews extending vertically from the leadscrew pulleys are contained within a frame. The frame is comprised of a base from which vertically extend a pair of side risers. The side risers are held at the top by way of a cross beam reaching across to both side risers. The leadscrews, starting from the leadscrew pulleys, pass through the base and continue upwards until they end inside the cross beam. Below the crossbeam is a press and the press is being driven downwards by the leadscrews. Centered within the frame are the removable liquid container, a removable blade container and a removable coconut container. The liquid container receives the liquid from the coconut. The liquid container sits underneath a pedestal. The pedestal supports a blade container which contains the blades.

Additionally, the blade container rests atop the pedestal and is held by an inside rim which forms the perimeter of an opening atop the pedestal.

In a variation, the coconut splitting device has the blade container having a cross frame which holds the set of blades.

The coconut splitting device has a method of operation consisting in the steps of the press is lowered by way of leadscrews so that it presses down against the lid; the coconut container is pushed down onto the set of blades; the coconut is split; the liquid from the coconut drips into the liquid container; once the coconut is split, the motor reverses direction, thus raising the coconut container back to its starting position.

Furthermore, the coconut splitting device has a coconut container having a diameter that is slightly smaller than that of the blade container so that it can slide within it.

A sleeve provides friction against the coconut container.

In an alternate embodiment, the coconut splitting device has an external body with a door to access the inner mechanism.

The liquid container has a filtering screen sitting on it.

The blades consists of a pair of perpendicularly crossed blades.

A centering ring is used for centering the coconut as the press bears down.

The centering ring has biased pins connecting the centering ring to the underside of the lid and the biased pins position the centering ring so that it transfers the pressure from the press onto the coconut.

The filtering screen keeps chunks and debris out of the liquid container.

Atop the blade container is a coconut container which has a removable bottom.

The bottom has slits to allow passage of the set of blades.

The coconut container has a lid and underneath that lid is a centering ring mechanically attached to the underside of the lid by way of biased pins.

The top of the lid has a lid handle that is configured and sized to engage a hook.

The hook extends integrally from the press.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Perspective view of the invention inside a closed container.

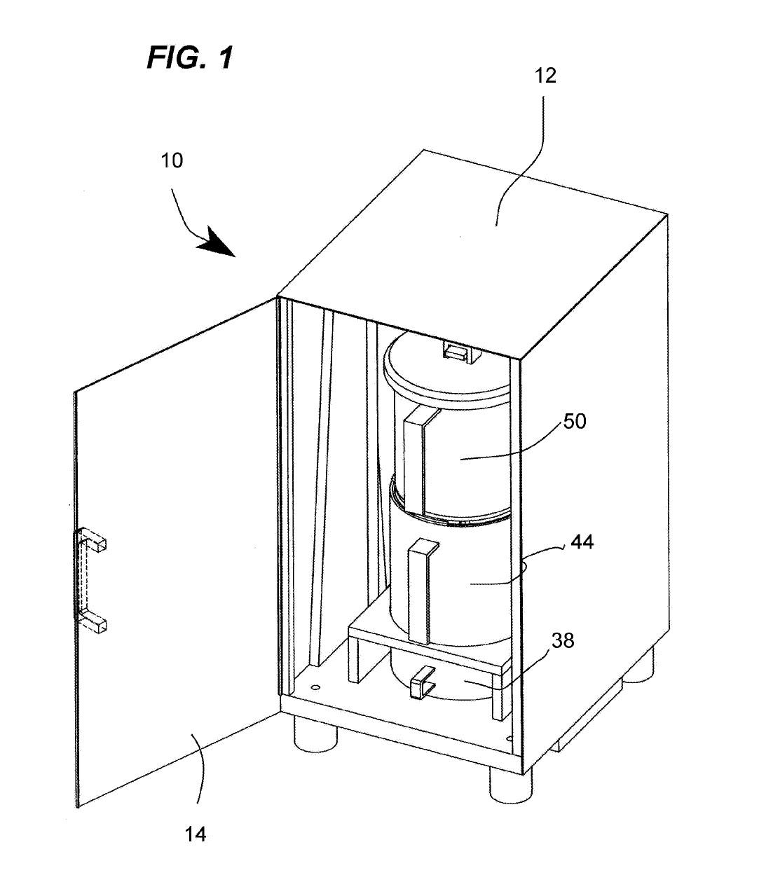

FIG. 2 Front view of the invention.

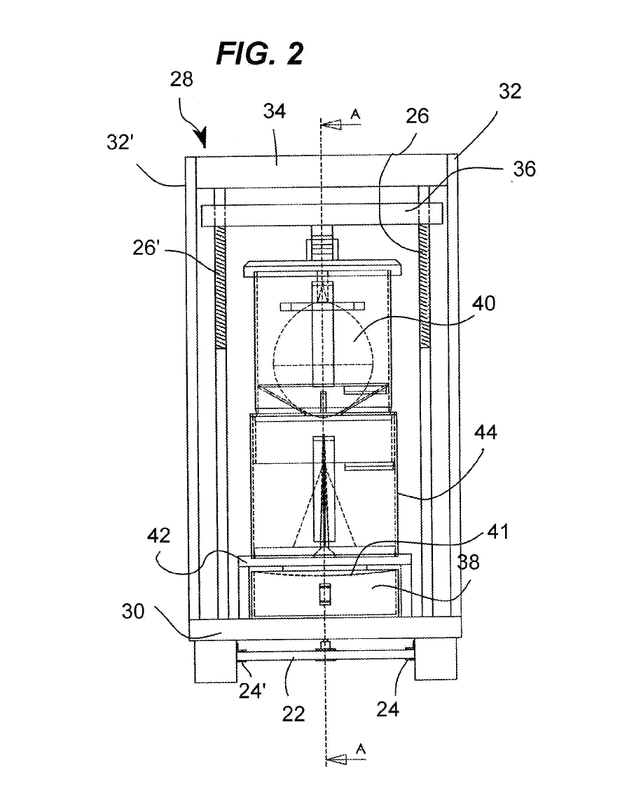

FIG. 3 Cutaway view along line A-A of FIG. 2.

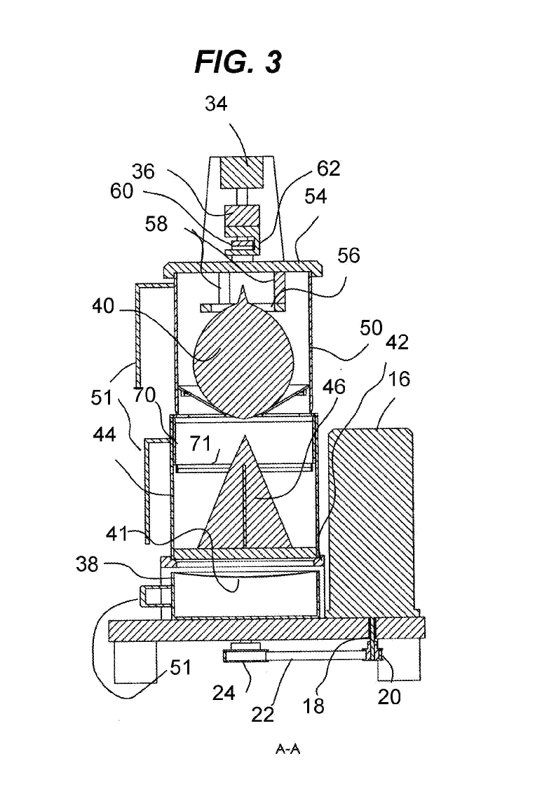

FIG. 4 Perspective view of the invention without the container.

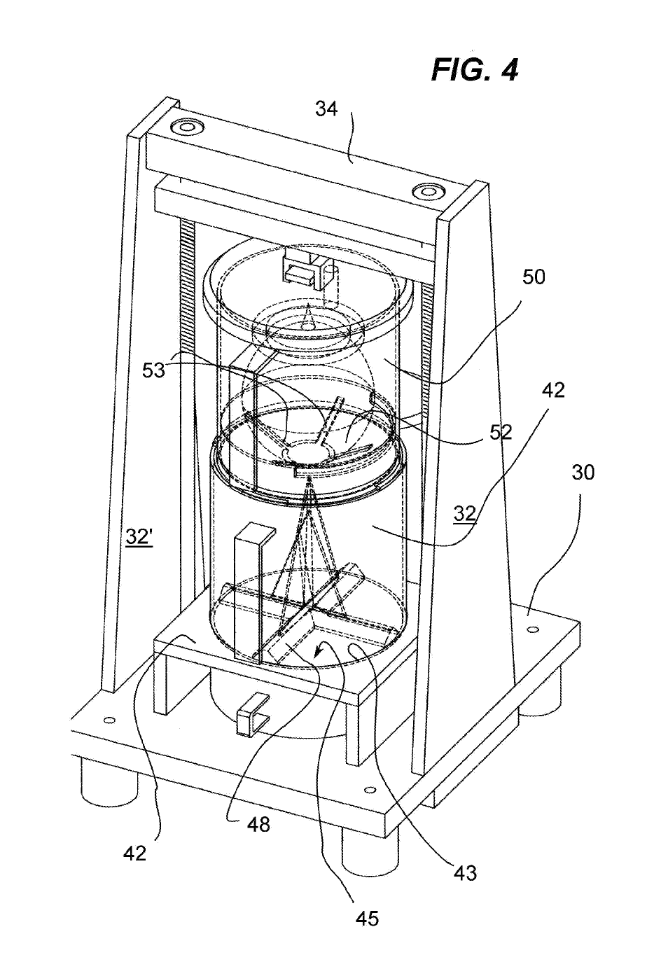

### DETAILED DESCRIPTION

A coconut splitting device (10) comprising an external body (12) with a door (14) to access the inner mechanism. The body (12) is in the shape of a rectangular box for illustrative purposes but is not restricted to any specific shape.

An electrically powered motor (16) has a motor shaft (18) extending therefrom. The motor shaft (18) is itself mechanically attached to a motor pulley (20) that drives a belt (22). It is understood that it is within the scope of the invention that the motor pulley (20) could be advantageously replaced by a sprocket wheel and that the belt (22) could be replaced by a chain.

The belt (22) links two other pulleys known as leadscrew pulleys (24, 24′) before closing back on the motor pulley (20).

A pair of leadscrews (26, 26′) extending vertically from the leadscrew pulleys (24, 24′) are contained within a frame (28). The frame (28) is comprised of a base (30) from which vertically extend a pair of side risers (32, 32′). The side risers (32, 32′) are held at the top by way of a cross beam (34) reaching across to both side risers (32, 32′).

The leadscrews (26, 26′), starting from the leadscrew pulleys (24, 24′), pass through the base (30) and continue upwards until they end inside the cross beam (34).

Below the crossbeam (34) is a press (36). The press is being driven downwards by the leadscrews (26, 26′).

Centered within the frame (28) are three containers. Starting from the bottom, there is a liquid container (38) which receives the liquid from a coconut (40). The liquid container (38) sits underneath a pedestal (42) and is removable so that a user can take the liquid from it. The liquid container (38) can have a filtering screen (41) sitting on it.

The pedestal (42) supports a blade container (44) which contains a set of blades (46). The set of blades (46) consists of a pair of perpendicularly crossed blades. This configuration is optimally configured for splitting coconuts but since there are a variety of coconuts it is possible that the blade shape be different than those illustrated here by way of example without departing from the scope of this invention. The blade container (44) simply rests atop the pedestal (42) and is actually held by an inside rim (43) which forms the perimeter of an opening (45) atop the pedestal (42). The blade container (44) itself does not have a bottom but rather a cross frame (48) which holds the set of blades (46).

Atop the blade container (44) is a coconut container (50) which has a removable bottom (52). The bottom has slits (53) to allow passage of the set of blades (46). The coconut container (50) has a lid (54) and underneath that lid (54) is a centering ring (56) mechanically attached to the underside of the lid (54) by way of biased pins (58). The centering ring (56) is used for centering the coconut (40) as the press (36) bears down. The biased pins (58) help in arranging the centering ring (56) so that it transfers the pressure from the press (36) onto the coconut (40) while properly centering it since coconut come in various shapes and sizes.

The top of the lid has a lid handle (60) that is configured and sized to engage a hook (62). The hook (62) extends integrally from the press (36). This hook (62) and lid handle (60) allows for easy installation and removal of the coconut container (50) fitted with its lid (54) which is frictionally engaged onto the coconut container (50).

All three containers (38, 44, 50) have a handle (51) to facilitate handling as all three containers (38, 44, 50) are removable.

When the leadscrews (26, 26′) are in motion in, depending upon their rotational direction, they will lower or raise the press (36).

In a first example, the press (36) is lowered and as such, it presses down against the lid (54) by way of the hook (62) and handle (60). this action pushes the coconut container (50) down onto the set of blades (46), thus splitting the coconut (40). The liquid drips into the liquid container (38).

The filtering screen (41) keeps chunks out of the liquid container (38). Once the coconut (40) is split, the motor (16) automatically reverses direction, thus raising the coconut container (50) back to its starting position. This type of automated downward and upward controlled motion is well known in various arts and need not be further discussed here. Basically, various types of sensors determine a given course for the coconut container (50) so that when the course is done, the course direction is reversed back to the starting point. Also, it is a given that there is a power cord to provide power to the electric motor (16), and that there is an on off switch but these mere details would distract from the true nature of the invention.

The coconut container (50) has a diameter that is slightly smaller than that of the blade container (44) so that it can slide within it. To further guide the coconut container (50), a sleeve (70) provides slight friction against the coconut container (50). The sleeve (70) has a sleeve supporting structure (71) to provide structural support and structural integrity. Likewise, a removable bottom supporting structure (53) provides structural support and structural integrity to that part.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. For example, although preferred, the electric motor (16) and leadscrews (26, 26′) could be replaced by at least one hydraulic piston and a compressor while still having the press (36) pressing down against the lid (54).

1. A coconut splitting device comprises:
a lowering means to lower a coconut onto blades;
the blades splitting the coconut;
a liquid container to collect liquid from the split coconut.

2. A coconut splitting device as in claim 1 wherein:
the lowering means is in the form of
an electrically powered motor with a motor shaft extending therefrom;
the motor shaft is itself mechanically attached to a motor pulley;
the motor pulley drives a closed belt to which it is mechanically connected;
a pair of leadscrews extending vertically from the leadscrew pulleys are contained within a frame;
the frame is comprised of a base from which vertically extend a pair of side risers;
the side risers are held at the top by way of a cross beam reaching across to both side risers;
the leadscrews, starting from the leadscrew pulleys, pass through the base and continue upwards until they end inside the cross beam;
below the crossbeam is a press;
the press is being driven downwards by the leadscrews;
centered within the frame are the removable liquid container, a removable blade container and a removable coconut container;
the liquid container receives the liquid from the coconut;
the liquid container sits underneath a pedestal;
The pedestal supports a blade container which contains the blades.

3. A coconut splitting device as in claim 2 wherein:
the blade container rests atop the pedestal and is held by an inside rim which forms the perimeter of an opening atop the pedestal.

4. A coconut splitting device as in claim 2 wherein:
the blade container has a cross frame which holds the set of blades.

5. A coconut splitting device as in claim 2 having a method of operation consisting in the steps of:
the press is lowered by way of leadscrews so that it presses down against the lid;
the coconut container is pushed down onto the set of blades;
the coconut is split;
the liquid from the coconut drips into the liquid container;
once the coconut is split, the motor reverses direction, thus raising the coconut container back to its starting position.

6. A coconut splitting device as in claim 2 wherein:
the coconut container has a diameter that is slightly smaller than that of the blade container so that it can slide within it.

7. A coconut splitting device as in claim 2 wherein:
a sleeve provides friction against the coconut container.

8. A coconut splitting device as in claim 1 wherein:
there is an external body with a door to access the inner mechanism.

9. A coconut splitting device as in claim 1 wherein:
the liquid container has a filtering screen sitting on it.

10. A coconut splitting device as in claim 1 wherein:
the blades consists of a pair of perpendicularly crossed blades.

11. A coconut splitting device as in claim 2 wherein:
a centering ring is used for centering the coconut as the press bears down.

12. A coconut splitting device as in claim 11 wherein:
the centering ring has biased pins connecting the centering ring to the underside of the lid;
the biased pins position the centering ring so that it transfers the pressure from the press onto the coconut.

13. A coconut splitting device as in claim 9 wherein:
the filtering screen keeps chunks and debris out of the liquid container.

14. A coconut splitting device as in claim 2 wherein:
atop the blade container is a coconut container which has a removable bottom.

15. A coconut splitting device as in claim 14 wherein:
the bottom has slits to allow passage of the set of blades.

16. A coconut splitting device as in claim 2 wherein:
the coconut container has a lid and underneath that lid is a centering ring mechanically attached to the underside of the lid by way of biased pins.

17. A coconut splitting device as in claim 16 wherein:
the top of the lid has a lid handle that is configured and sized to engage a hook.

18. A coconut splitting device as in claim 17 wherein:
the hook extends integrally from the press.
